(19) United States
(12) Patent Application Publication
(10) Pub. No.: US 2018/0163447 A1
(43) Pub. Date: Jun. 14, 2018

(54) Access denying device

(71) Applicant: Brad Bokestyn, Sylvan Lake (CA)

(72) Inventor: Brad Bokestyn, Sylvan Lake (CA)

(21) Appl. No.: 15/530,165

(22) Filed: Dec. 9, 2016

(51) Int. Cl. E05C 19/18

(52) U.S. Cl. CPC E05C 19/188; E05B 13/001

(57) ABSTRACT

A restrictor having flexible adjustable arms so that it may fit various opening sizes and shapes. The overall shape can be crisscross or spider web design. Attachments such as clips, clamps or other fastening devices can be provided to make attachment to the perimeter of the opening easy.

### FIELD OF THE INVENTION

The present invention relates to an access denying device and, more particularly, to a device that prevents entry through doorways or port holes into areas where hazardous conditions exist.

### BACKGROUND OF THE INVENTION

Hazards exist in areas that can affect unaware workers, visitors and others. These hazards may not be obvious such as in poisonous gases, explosives, combustibles, structural hazards such as a possible floor or ceiling collapse and other potential deadly situations that a person would be unaware of. People who are unaware that these conditions even exist can stumble into them taking life or causing injury. Often additional danger is created when these harmed individuals need to be helped or rescued by others as they too attempt to enter the hazardous area without proper knowledge or protection taking even more lives. In other cases, entry into a hazardous area such as one with explosive materials can not only harm those directly in that area but may cause additional harm to surrounding areas or set off a chain reaction leading to many deaths and injuries as well as environmental disasters.

Currently solutions that exist are tape and signs. Tape is used to crisscross the door opening and must be attached to the wall by means of adhesive. Signs can be hung with adhesive or used in a sandwich board configuration to prevent people from entering.

Tape is not always easy to apply and can fall off due to moisture, oils and other situations on the surface that render it impractical for adhering to the contaminated surface. In bad light situations, these warning devices may be stumbled through. It is easy to remove these warnings by accident or on purpose allowing someone to enter the hazardous area without much effort. Signs can be moved or go unseen in smoky or poor light situations. Signs and warring's may be blown away because of severe weather conditions. They can be difficult to hang and sandwich boards take up a lot of room and can be easily moved or bumped causing them to collapse rendering them useless in preventing entry to hazardous areas. None of the other methods currently available provide a secure reliable means to deter people from entering hazardous areas.

It would be advantageous to provide a safety denying device that is easy and fast to attach securely.

It would also be advantageous to provide a device that prevents accidental entering a hazardous area.

It would further be advantageous to provide a device that is easily stored and very portable.

It would further be advantageous to provide a device that functions even in poor visibility conditions.

It would further be advantageous to provide a device that cannot easily become detached or moved accidentally.

### SUMMARY OF THE INVENTION

In accordance with the present invention, there is provided a restrictor having the flexibility so that it may fit various opening sizes and shapes. The overall shape can be crisscross or spider web design. Attachments such as clips, clamps or other fastening devices can be provided to make attachment to the perimeter of the opening easy.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a left perspective view of an expandable spider type net device that can be stretched over the opening and held in place through its contracting nature;

FIG. 2 is a front perspective view of the access denying device with its attached warning sign only partially in place over the opening;

FIG. 3 is a front elevation view of an entryway port showing bolt holes;

FIG. 4 is a front elevation view of an entry way port hole showing access denying device in place to stop entry;

FIG. 5 is a front detail view of an access denying device extended as if it were installed;

FIG. 6 is a rear detail view of an access denying device with retractable arms and tension device for causing retraction;

FIG. 7 is a side perspective view of a bolt hole plug in extended position; and

FIG. 8 is a side perspective view of a bolt hole plug in its expanded position snug against the bold hole side walls.

For purposes of clarity and brevity, like elements and components will bear the same designations and numbering throughout the Figures.

### DESCRIPTION OF THE PREFERRED EMBODIMENT

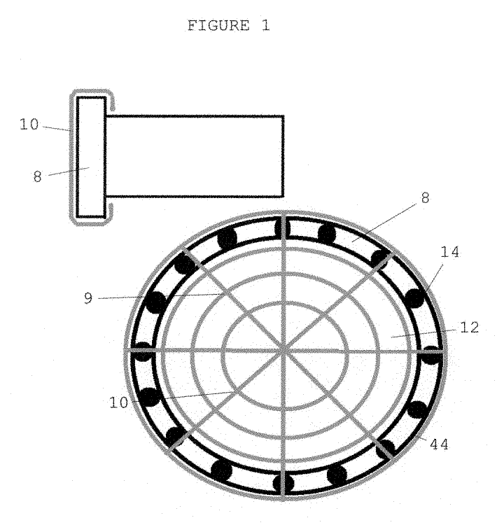

FIG. 1 is a left perspective view of an expandable spider web like 9 type net device that can be stretched over the opening and held in place through its contracting nature.

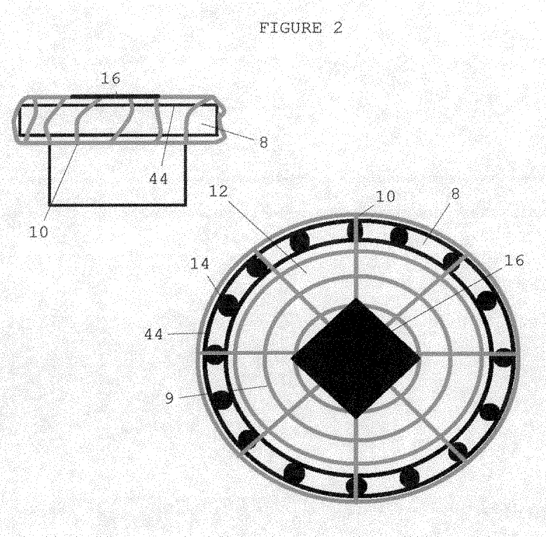

FIG. 2 is a front perspective view of the access denying device 22 with its attached warning sign 16 only partially in place over the opening.

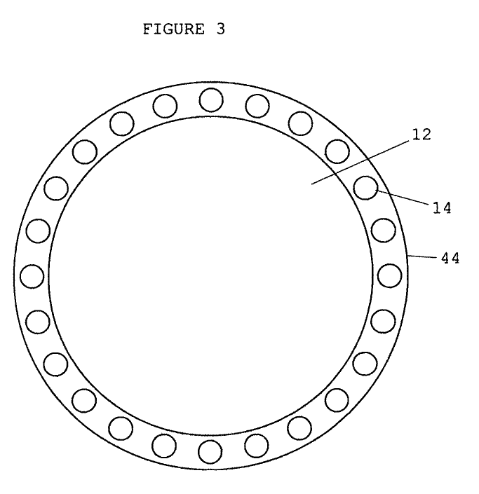

FIG. 3 is a front elevation view of an entryway port showing bolt holes 14.

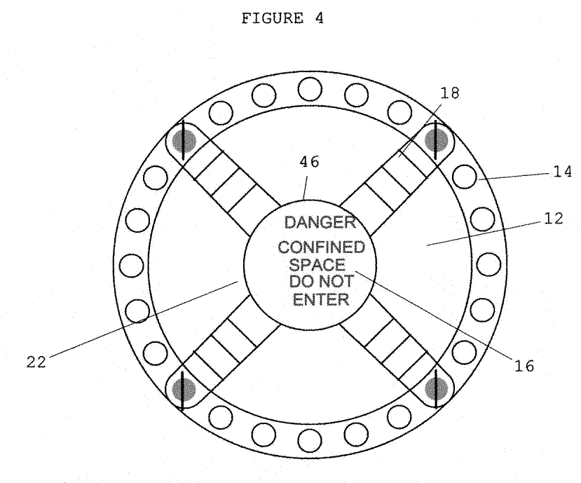

FIG. 4 is a front elevation view of an entry way port hole 12 showing access denying device 22 in place to stop entry.

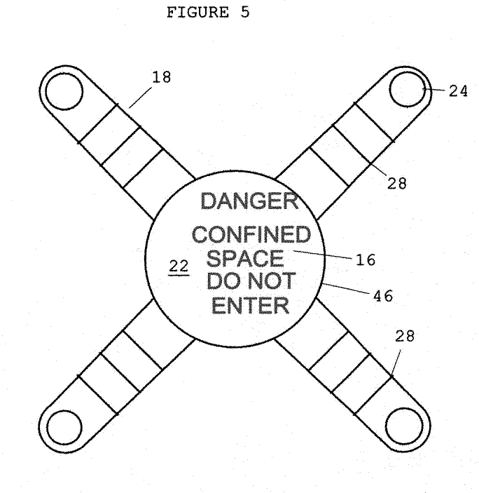

FIG. 5 is a front detail view of an access denying device 22 extended as if it were installed.

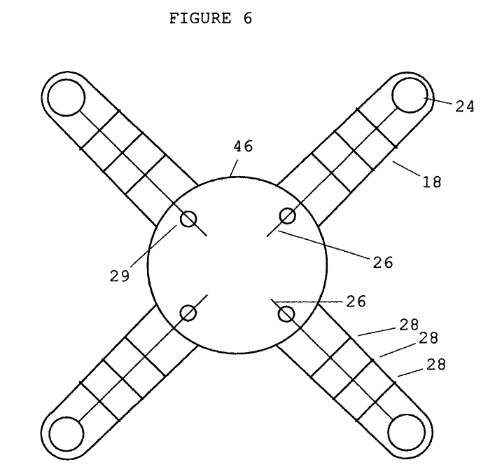

FIG. 6 is a rear detail view of an access denying device 22 with retractable arms 18 and tension device 26 for causing retraction.

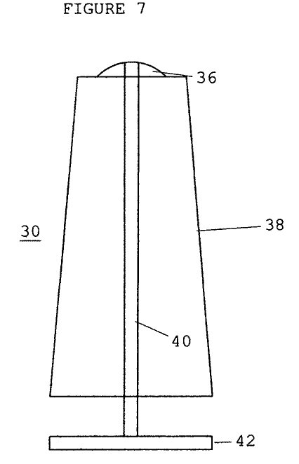

FIG. 7 is a side perspective view of a bolt hole plug 30 in extended position.

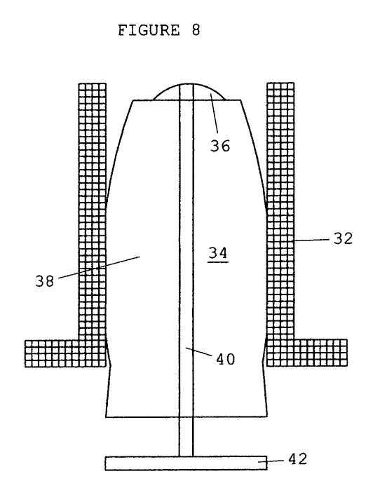

FIG. 8 is a side perspective view of an expanded bolt hole plug 34 in its expanded position snug against the bold hole side walls.

FIG. 1 shows a preferred embodiment of the present invention including a net like device called a denying net 10 with strong tension capable of stretching over a port hole 12. The device consists of a very strong flexible type material such as cable as an outer ring 8 that can be locked for security and spider web like 9 elastic type materials are linear and circular lines creating a strong retractable ability. The devices outer ring 8 is such that it is not easily removed from the port hole bolt flange 44 as its diameter can be reduced to smaller than the diameter of the port hole bolt flange 44 and locked or secured from being easily removed. Yet flexible enough to fit various sizes of portholes without changing actual retracted dimensions of the device.

FIG. 2 shows a preferred embodiment of the present invention including a warning sign 16 securely attached to it to notify persons not to enter the port hole 12 due to dangerous conditions that may be hazardous to a person's health or safety. The present invention is depicted as being partially wrapped around the port hole bolt flange 44. The port hole bolt flange 44 extensions from the port hole 12 allowing for the easy attachment of the access denying device 22.

FIG. 3 shows a port hole bolt flange 44 with empty bolt holes 14. This port hole bolt flange 44 is what the access denying device 22 is attached to.

FIG. 4 shows a second preferred embodiment of the preset invention made with rigid retractable arms 18. Not all port hole 12 or access points may contain an extended flange there for a second preferred method is required. this version of the access denying device 22 consist of a mounting platform 46 with at least one retractable arm designed to be self-adjusting. The self-adjusting arm (s) causes the device to automatically adjust in size to fit various sized port hole 12 openings. The preferred embodiment shown includes four of the at least one retractable arms 18 required and a warning sign 16 securely attached to the mounting platform 46. The warning sign 16 serves to notify any persons that entering the denied area will be a very dangerous move on their part and they should not enter. Such conditions commonly exist in areas where petroleum, natural gas or other minerals are being drilled or mined for. Such a device must be adjustable yet securable to port entries to reduce human exposure to such hazards.

FIG. 5 shows the access denying device 22 in its deployed position. The bolt hole plugs are in place securing the device to the port hole bolt flange 44.

FIG. 6 shows the rear of the access denying device 22 details including the tension device 26 that causes the arms to retract toward the mounting platform 46. The tension device 26 can be made of an elastic type material strong enough to cause the retractable arms 18 to retract when free yet allow them to extend with sufficient tension to move the bolt plug hole 24 to match the bolt holes 14. each section of the arm slides 28 nestle inside of the next portion of the retractable arms 18 as the tension device 26 retracts the retractable arms 18 the opposite occurs as the retractable arms 18 are extended. The tension device hole 29 permits an adjustment of the tension device 26 so that more-or-less tension can be applied to the retractable arms 18 as needed.

FIG. 7 is of the bolt hole plug 30 as it would be when inserted through the bolt plug hole 24 into the bolt holes 14 prior to expanding and securing the bolt hole plug 30 in the bolt holes 14. The bolt hole plug 30 is a standard expanding plug consisting of a handle 42 to turn the adjusting screw for tightening or loosening the device by means of retracting or extending the end washer 36. As the end washer 36 is retracted it compresses the bolt hole plug 30.

FIG. 8 shows the bolt hole plug 30 expanded due to its retracted position inside of a bolt holes 14. Upon tightening of the threaded screw 40 by means of twisting the Handle 42 in a clock wise direction, the rubber 38 is compacted by the retracting end washer 36 causing the rubber 38 to shorten but widen securing it to the inside of the bolt hole wall 32. The purpose is to provide an attachment that will work in various size holes as well as various threads per inch without the need for multiple plugs and reducing the possibility of a cross threaded bolt hole rending it in operative for present and possible future use without repair.

Since other modifications and changes vary to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An access denying device for denying access to doors and port holes where hazards exist, comprising:
means for securing the device over the port hole bolt flange. it is tightenable and or lockable to prevent easy removal of the access denying device;
means for restricting access to doors or port holes;
means for warning any persons not to enter because of dangerous conditions;
means for adjusting the access denying device to fit the opening of the door or port hole;
means for denying access to a door or port hole;
means for retaining the device in a tension state to prevent access to a port hole while allowing the device to be adjustable for various sized openings;
means for allowing the arms to nest inside of each other adjusting for arm movement regulated by various port opening diameters; and
means for making the net like device contract creating tension for retention of the net like device over the port hole.

2. The access denying device in accordance with claim 1, wherein said means for securing the net like device over the port hole bolt flange. it is tightenable and securable to prevent easy removal of the access denying device comprises a cable, securable or lockable outer ring.

3. The access denying device in accordance with claim 1, wherein said means for restricting access to a port hole comprises an expandable, circular, tensionable denying net.

4. The access denying device in accordance with claim 1, wherein said means for warning any persons not to enter because of dangerous conditions comprises a highly noticeable warning sign.

5. The access denying device in accordance with claim 1, wherein said means for adjusting the access denying device to fit the opening of the port hole comprises a retractable, moveable, durable-retractable arms.

6. The access denying device in accordance with claim 1, wherein said means for denying access to a port hole comprises a durable, adjustable access denying device.

7. The access denying device in accordance with claim 1, wherein said means for retaining the arms in a tension state to prevent access to a port hole while allowing the device to be adjustable for various sized openings comprises a tensionable tension device.

8. The access denying device in accordance with claim 1, wherein said means for allowing the arms to nest inside of each other adjusting for arm movement regulated by various port opening diameters comprises a slideable arm slides.

9. The access denying device in accordance with claim 1, wherein said means for making the net like device contract creating tension for retention of the net like device over the port hole comprises an elastic spider web like.

10. An access denying device for to deny access to doors where hazards exist, comprising:
a cable, lockable outer ring, for securing the net like device over the port hole bolt flange. it is tightenable and lockable to prevent easy removal of the access denying device;
an expandable, circular, tensionable denying net, for restricting access to a port hole;
a highly noticeable warning sign, for warning any persons not to enter because of dangerous conditions;
a retractable, moveable, durable-retractable arms, for adjusting the access denying device to fit the opening of the port hole;
a durable, adjustable access denying device, for denying access to a port hole;
a tensionable tension device, for retaining the arms in a tension state to prevent access to a port hole while allowing the device to be adjustable for various sized openings;
a slideable arm slides, for allowing the arms to nest inside of each other adjusting for arm movement regulated by various port opening diameters; and
an elastic spider web like, for making the net like device contract creating tension for retention of the net like device over the port hole.

11. An access denying device for to deny access to doors where hazards exist, comprising:
a cable, lockable outer ring, for securing the net like device over the port hole bolt flange. it is tightenable and lockable to prevent easy removal of the access denying device;
an expandable, circular, tensionable denying net, for restricting access to a port hole;
a highly noticeable warning sign, for warning any persons not to enter because of dangerous conditions;
a durable, adjustable access denying device, for denying access to a port hole;
an elastic spider web like, for making the net like device contract creating tension for retention of the net like device over the port hole.

12. (canceled)
